(19) United States
(12) Patent Application Publication
(10) Pub. No.: US 2005/0129191 A1
(43) Pub. Date: Jun. 16, 2005

(54) System and method for a communication network including an automatic call answering function such as a voice mail server

(75) Inventors: Marko Kokko, Oulu (FI); Kirsi Maansaari, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/816,927

(22) Filed: Apr. 5, 2004

(30) Foreign Application Priority Data
Dec. 16, 2003 (EP) 03028895.5

(51) Int. Cl. H04M 11/00; H04M 1/64

(52) U.S. Cl. 379/88.13; 379/88.17

(57) ABSTRACT

The invention provides a method, system, terminal, server, and computer program product for providing or programming a call response function, preferably a voice mail function, in a communication network which includes a call response server having a storing means. The method, terminal, system, and computer program product comprise the steps of preparing or providing, in the terminal, a programming media message, such as an MMS message, which includes response content, preferably audio content. This programming media message is transmitted from the terminal to the call response server which stores the response content of the media message. When a call or session request of another terminal directed to the terminal is forwarded to the call response server the response content is played or transmitted to the another terminal.

### FIELD AND BACKGROUND OF THE INVENTION

The present invention relates to a method, system and network element for implementing an automatic call response function such as a voice mail server, VMS, function. In particular but not restricted thereto, the invention relates to programming an automatic call answering (or response) function such as a voice mail server using a media or multimedia message, for example MMS (Multimedia Messaging Service), and, additionally or alternatively, to an automatic answering system and server such as a voice mail system or server which provides audio-rich messages and/or multimedia messages.

Presently the announcement of a voice mail (or more generally of an automatic answering machine) is typically either preprogrammed by the service operator with a default message, or self-personalized by the user by calling users voice mail service, keying a PIN, browsing through menus using phone's keypad to select “record your personal announcement”, and finally “live”-recording the announcement.

FIG. 6 illustrates a customary method for programming a voice mail server, VMS 24, in the context of mobile phone networks. A user establishes a voice call 22, using user equipment 21, to his/her VMS 24. The voice call 22 is transmitted via Mobile Switching Center, MSC, 23. The VMS 24 authenticates and authorizes the caller using caller's phone number and an access code prompted from, and input by, the caller. The user follows audible instructions of the VMS 24 and selects recording of new announcement using a keypad (DTMF tones) of the equipment 21. The VMS 24 starts to record caller's speech and continues to record it until user sends “end mark” using keypad (DTMF tone), or a predefined recording time is exceeded. The user may listen to his/her new recording and accept/reject the recording by following audible instructions of the VMS. Finally, the user hangs up, that is terminates the call 22, and the VMS 24 stores the announcement for playback.

Basically only live-recorded voice announcements are possible and caller id based differentiation is not feasible.

### SUMMARY OF THE INVENTION

The invention provides a method as defined in any one of the method claims. Further, the invention provides a system and terminal as defined in any one of the system or terminal claims, and an automatic call response server such as a voice mail system, as defined in any one of the server claims. Further, the invention provides a computer program product as defined in any one of the computer program product claims.

The invention provides a method, system, terminal, computer program product, and server for programming or providing a call response function, preferably a voice mail function, in a communication network which includes a call response server, preferably a voice mail server VMS, having a storing means. The method and system comprise the steps of preparing or providing, in a terminal, a programming media message which may be an MMS message, SIP message etc. The programming media message includes response content, preferably audio content. This media message is transmitted from the terminal to the call response server, e.g. VMS, which stores the response content of the media message in the storing means. The response content is stored for, or associated to, the user of the terminal as an automatic call response for that user.

When a call or session request of another terminal directed to the user of the terminal is forwarded to the server the response content is played, and/or transmitted, to the another terminal.

Preferably, the programming media message, or at least the response content thereof, is stored in the server, e.g. VMS, or another entity. When a call of another terminal is forwarded to the server, the stored media message, or at least its response content, may be transmitted to the another terminal. This transmitting of the stored media message, or at least its response content, may always take place when a call is forwarded to the server. In this case, a response media message can always be sent to the caller without any knowledge about the media capabilities of the caller's terminal. The idea behind the checking/detecting is to adapt the response message to suit caller's specific terminal capabilities. In a more refined embodiment, the server has a function of checking or detecting whether a calling terminal, the call of which is forwarded to the server, has media, e.g. MMS, capability. Only when detecting that the calling terminal has media capability, the stored media message, or at least its response content, may be transmitted to the calling terminal. Further, depending on the check result, the response message may also be adapted to the detected media capabilities of the calling terminal. This provides additional service to a calling party and allows transmittal of video or other visual information as an automatic call response.

When the programming media message, e.g. MMS message, sent to the server for response programming, includes application specific content such application specific content is processed and stored in the server. The application specific content may be removed before storing the message for later transmittal to a caller.

When sending the stored response content of the programming media message to a caller in the form of a media message, the response content may, but need not necessarily, be played to the caller in addition to the sending of the media message.

For alleviating creation or selection of the programming media message for response server programming, two or more media messages with different response contents are preferably provided, and the user of the terminal selects one or more of the provided media messages, in particular MMS messages. The selected media message or messages are transmitted to and processed in the server as programming media messages.

The media message may include a caller identification information which is used to associate the response content of the message to a caller of a call or session forwarded to the server.

Preferably, the server stores at least two response contents associated to the same user of the terminal generating the programming media message and to different caller identification informations. This allows to play or send different automatic call responses to different callers. The server detects or checks the caller, when a call or session request of another terminal directed to the user of the terminal is forwarded to the server, and transmits, to the another terminal, the stored response content which is associated to the first terminal and to the caller identification information corresponding to the detected caller.

The server may be implemented as a VMS or in a MMS center, MMSC.

The invention provides an improvement of programming or performance of the automatic call answering.

Generally, the invention provides at least one or more of the following features:

(1) Programming voice mail announcement using a media messaging service such as MMS (replacing the previous method to store a voice mail announcement in VMS),

(2) Delivering, to a caller, a voice mail announcement/response using a media messaging service such as MMS (supplementary feature to send a voice mail announcement, and/or multimedia),

(3) Programmable voice mail service (intelligent voice mail server that can be programmed using media messaging such as MMS or SIP. Multifunctional programming possibilities using e.g. per caller, time of day, are provided,

(4) An application for programming voice mail service, that is a terminal application that implements the user interface for features 1 and 3 above.

The invention furthermore provides, according to one aspect, a computer program product adapted to be installed in a terminal, preferably as defined in above or in the following, which is adapted for creating programming media messages for programming a call response server. The computer program product preferably is an application adapted to handle messaging with the call response server. The application may alternatively or additionally be adapted to assist the user in creation of programming media messages. The application may provide assistance in the form of pre-defined or user modifiable forms displayed to the user for filling in. Further, the application may comprise or use a storage within the terminal for storing a library of previously created or pre-defined programming media messages. The application is preferably adapted to store information on at least one of the status of the automatic call response service and its history.

The computer program product may be stored on a data carrier such as a memory card, CD-ROM etc, or may be downloaded to the terminal in a wireless manner, e.g. from a provider or the Internet.

### BRIEF DESCRIPTION OF THE DRAWINGS

FIG. 1 shows a basic structure of an embodiment of the invention; and

FIG. 2 illustrates implementation details of the structure of an multimedia programming message used in an embodiment of the invention such as shown in FIG. 1,

FIG. 3 shows an embodiment of a process for programming a VMS in accordance with the invention,

FIG. 4 shows an embodiment of a call response process for responding to a call in accordance with the invention,

FIG. 5 illustrates an implementation of a structure of a (multi)media message used in an embodiment of the invention for responding to a caller, and

FIG. 6 illustrates a previous approach for programming a VMS.

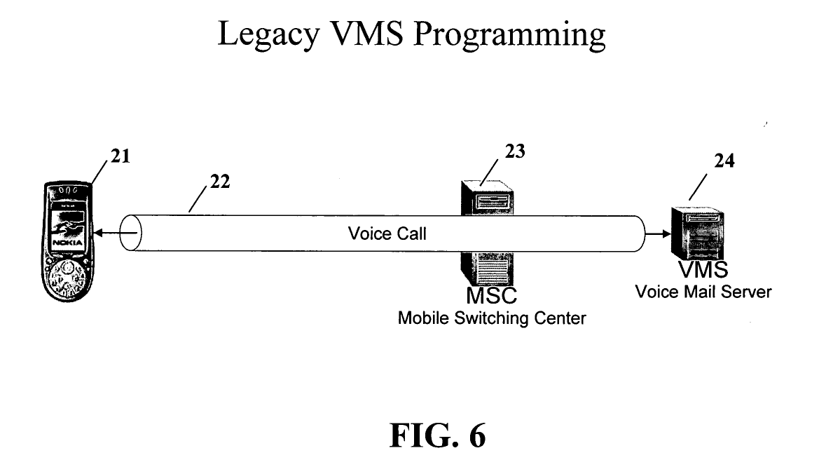

### DETAILED DESCRIPTION OF PREFERRED EMBODIMENTS OF THE INVENTION

In accordance with a preferred embodiment of the invention, a user creates, or selects, a programming media message, e.g. multimedia message such as an MMS message, using his/her mobile terminal or any other means such as a computer. The created or selected media message includes response content such as audio (acoustic) content, and may in addition or alternatively contain one or more elements of multimedia content, such as images, animations and video clips. In a next step, the user sends the created or selected programming media message to a pre-specified recipient (e.g. the voice mail number or VMS) which stores the response content of the message for automatic call answering of calls or sessions forwarded to the recipient when the user is unavailable, busy, or unwilling to answer the call. The audio contentis then played back to a caller when a call is terminated at the answering machine.

The user can have several pre-recorded MMSs stored in his terminal, which makes it easier to change the voice mail announcement.

It is convenient, effective and versatile for the user to create, “offline”, a multimedia announcement, for example a voice mail announcement, possibly containing own voice, music and other noises the user wants to include to the automatic call response service. During or after creation, the announcement can be checked for possible errors or desired amendments, and corrected if desired. The complete created announcement will then be “uploaded” to the server, for example the VMS or MMSC, for later replay or transmission to a caller. This is more effective than the previous “on-line” live-recording of a voice message.

Also image or graphics may be included in the programming media message response content of which can only be presented to a caller having multimedia-capable, e.g. MMS-capable, terminal.

It is feasible to customize announcements for different callers using programming media message, e.g. MMS containing application specific content.

It is possible to create audio-rich announcements containing whatever audio content (voices, tones, noises, music, other personal audio recordings).

The announcements can be created/recorded offline.

The user can generate and/or store a library of different announcements in his/her mobile terminal where the announcements are ready to be uploaded to the service instantly and silently when the user so desires.

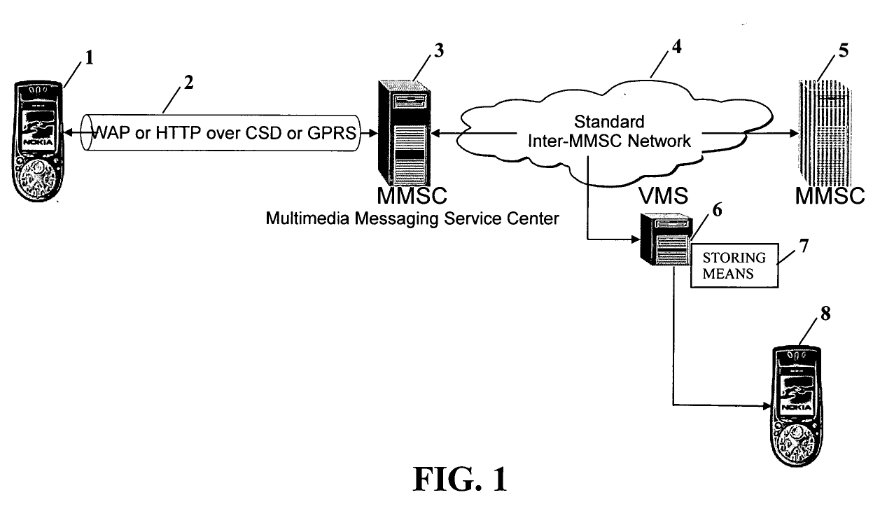

Basically, FIG. 1 shows a embodiment of a method and system for automatic response programming, e.g. voice mail VMS programming, in accordance with the present invention whereina message transmitting network, e.g. a multimedia network such as an MMS—Network (MMS, Multimedia Messaging Service) is used.

First, a user creates or selects a media or multimedia content using user equipment 1. This (multi)media content includes the audio and/or visual content the user wishes to be played to a caller as an automatic call answering service. This content is embedded in a programming media message, preferably of MMS-type. The user, using user equipment 1, then transmits the media message to a media messaging center, e.g. Multimedia Messaging Service Center, MMSC, 3, e.g. by establishing or using a connection or session 2 between the user equipment 1 and the messaging center, e.g. MMSC 3. The connection or session 2 may use WAP, Wireless Application Protocol, or HTTP, HyperText Transfer Protocol, over CSD, Circuit Switched Data, or GPRS, General Packet Radio Service. The programming media message is stored in the center 3, and forwarded to a Voice Mail Server, VMS, 6 possibly through another media messaging center, e.g. MMSC 5, via a Standard Inter-MMSC Network 4.

The media or multimedia message, e.g. MMS message, used for call answering or voice mail programming has a pre-specified format including e.g. PIN (Personal Identification Number) and/or other data needed to ensure user privacy/security.

The message may be extended to include also other announcement parameters, such as calling line indication information used to differentiate announcements or responses for different callers.

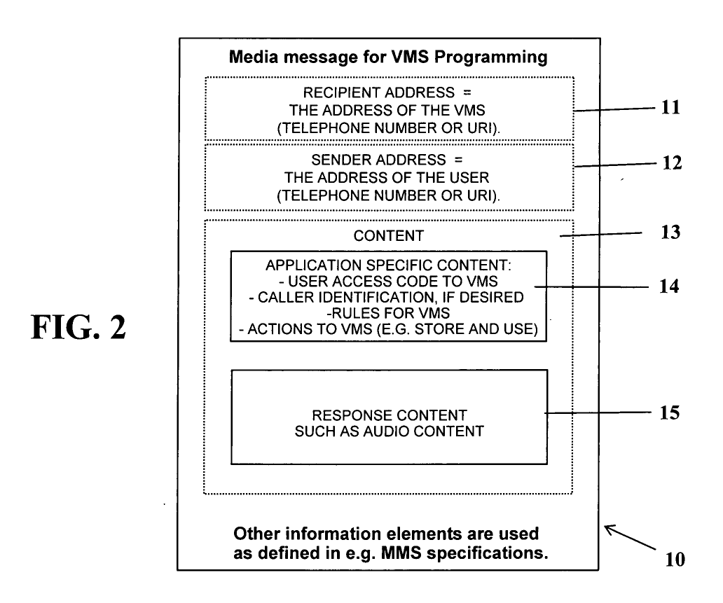

FIG. 2 illustrates a structure of a programming media message, in this example an MMS message 10, used for the VMS Programming according to an embodiment of the invention.

Generally, the “Programming” media message 10 is applied to carry two type of information:

1) instructions for programming the VMS (application specific content parameters such as described below);

2) response content elements which are to be played back (audio) or sent (audio, pictures, video, text) to callers.

If the caller has a media, e.g. MMS, capable terminal, VMS 6 can sent appropriate response content to him/her in another media message, e.g. MMS message. This message is different from the messages used for programming the VMS. VMS generates this new media message (1) according to the instructions and (2) based on the response content elements the VMS has received in “programming” messages.

VMS 6 may also use “default” elements provided by the VMS if so instructed. Such “default” elements or defaults settings are preferably provided by the service provider. In practise the default elements may preferably be used to provide standard announcements. If a user has not yet programmed his or her voice mail service, callers would hear standard announcement of the operator, e.g. “Please leave your message after the peep-tone . . . ”. As a possibility, in the case of MMS-messages, an operator-created MMS-message may be sent to the caller inviting the caller to send an MMS-message to the callee.

The programming media message 10 shown in FIG. 2 includes

a field 11, Recipient address=address of the VMS (telephone number or URI),
a field 12, Sender address=address of the user (telephone number or URI), a content section 13, and
other information elements used as defined in MMS specifications.

The content section 13 includes a field 14, Application specific content, which indicates:
authentication and authorization information such as user access code to VMS,
rules for VMS, and/or caller identification information (if desired to send different responses to different callers),
actions to VMS (e.g. store and use). Field 14 may include some or all of the following “Application specific content” parameters:
   1) caller id (eg. different response messages to be played for different caller groups, caller authentication based on E.164 phone number or SIP address or any other unique identifier)
   2) time of call (eg. different message after office hours)
   3) controls for network provided information/assisted operation (eg. (a) time of call is adjusted to time zone of callee, handy for roaming users; (b) different messages based on callee's location)
   4) validity time (how long time the instructions are valid)
   5) PIN code authentication when programming VMS.

These parameters allows different responses to be played to different callers or at different calling times (times of day or different weekdays etc) differentiated according to the desire of the user programming his/her automatic response.

The content section 13 further includes a field 15, response content, e.g. audio content.

The response, e.g. audio content 15 includes the response, e.g. audio content selected or set-up/created by a the user of equipment 1, which audio content is to be played to a caller whose call is forwarded to the VMS 6. When a call is forwarded to the VMS 6, this audio content is replayed to the calling party.

The terminal 1 includes means or function, that is an application, for creating one or more media messages, e.g. MMS messages, for programming the voice mail server VMS 6. The means, function or application handles proper messaging with the “server” and preferably assists the user in creation of “programming messages” 10 so that the user does not need to compose the programming messages, eg. MMS messages manually. The application may provide assistance in the form of pre-defined or user modifiable forms that the user fills in during composing of the programming media messages. Also the application may provide storage for regularly used settings i.e. a “library of programming messages” and keep track of the status of the service and its log for later reference. The application includes a PIN code and other authentication data in MMS.

Generally, when referring to the “terminal” in the text, this term is intended to refer not only to the activities of the terminal (or of the user of with the terminal/application), such as making a call, or creating or sending the VMS-programming MMS message, but also to parameters or settings of the user of the terminal such as phone number or subscription and user services. There may be several terminals for one user and also one terminal may be used by several users in different times. In other words calls and messages may not be directly related to terminals but to the users (and their phone number and subscription).

The stripping and storing of non-voice-contents of the programming messages may be identical or similar to the processing of only-voice-content programming messages. Also processing of instructions is similar in both cases. Of course it is possible to create much much more complex response messages than plain audio announcements meaning that the instructions and rules are also more complex, but the logic and operation in both cases is basically the same.

The mobile terminal 1 may contain a dedicated application for voice mail announcement creation (recording, mixing etc.), management (for announcement library) and service programming (announcement uploading).

The voice mail system 6 has an interface to the media messaging system, e.g. MMS system 4, and is capable either of converting media format,e.g. MMS-format, audio to proprietary format for playback or direct playback of audio in a media message.

The invention can be implemented with additional and/or modified software in the voice mail system. Additional software in a mobile terminal 1 will ease and boost the use of the services based on the invention.

The following method steps will be carried out for programming VMS 6:

(1) User first creates, for example by using the user equipment 1, a programming media message 10, e.g. an MMS message, of pre-defined format containing audio-type or other response-type content 15 and instructions 14.

The instructions may be human readable text with key words (text-type content) or VMS application specific data (application-type content). The “programming” message may be created using specific terminal application and/or message templates. The message may also contain other types of content (e.g. images, text, video clip), which may be used if the voice mail service provides the possibility to response to a call by sending an “response” message or stream to the caller instead or in addition to playing an audio announcement.

The user may also select a preprogrammed MMS message, for example from a library of preprogrammed MMS messages stored in, or downloaded to, the user equipment 1. The user may also select a preprogrammed MMS message stored in another equipment such as in a internet server, and download this MMS message to the user equipment 1.

(2) User sends the media, e.g. MMS, message 10 to his/her VMS 6. The message 10 is delivered via the user's messaging center, e.g. MMSC 3, to the VMS 6 using standard features such as inter-MMSC mechanisms.

(3) VMS 6 validates the received message 10 (e.g. checks the message syntax, integrity and content formats).

If the check fails (e.g. errors in the message or authentication fails), the message 10 is rejected and the user may be notified.

If the check is passed, the VMS 6 processes the instructions contained in field 14, e.g. the store and use commands, and stores the audio-content 15 for playback.

If the voice mail service supports sending “response” messages or streams also contents of other content types are stored.

Storing may require content processing such as converting the audio to another coding format (e.g. from AMR to PCM). This conversion is done by the VMS 6 if necessary.

When a caller identification should be included in the MMS message, e.g. in field 14, the audio content 15 is stored in the VMS 6 associated with the caller identification.

The instructions are used to define the rules for “audio announcement playback” and “response messages/streams”.

(4) VMS 6 notifies the user of successful programming of the call response service, that is VMS 6.

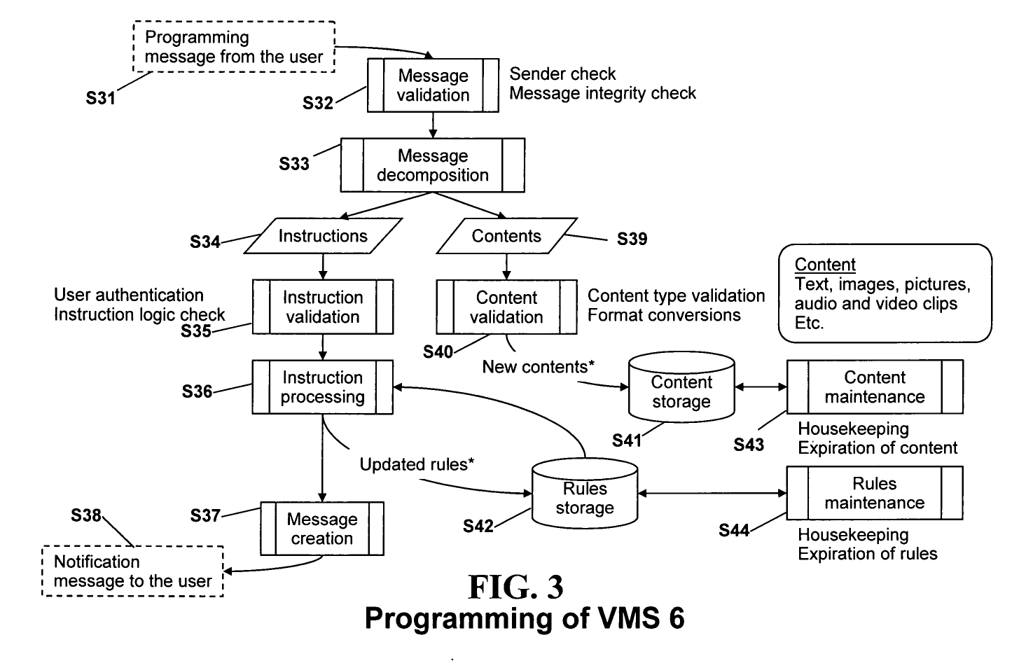

FIG. 3 illustrates an embodiment of a method and means or function for programming the automatic call response, e.g. voice mail service.

In a step S31, a programming media message 10 is sent from the terminal 1 to the VMS 6 or another means for programming VMS 6.

In a step S32, a message validation of the received programming message 10 is performed which preferably includes at least one of a Sender check and/or a Message integrity check based on the field 12 of the message 10. The message 10 is then subjected to a message decomposition in a step S33 in which the instructions S34 contained in the message 10, in particular in field 14 thereof, and the contents S39 contained in the message 10, in particular in field 15 thereof, are detected, that is read out from the message, and stored for further processing.

In a step S35, an instruction validation is performed which preferably includes a user authentication and authorization, and/or an instruction logic check of the instructions detected in step S34.

Subsequent to step S35, a step S36 is executed for instruction processing of the instructions derived in step S34 and validated in step S35.

When the instructions contained in field 14 of message 10 require a change of the rules for the VMS such as change of the waiting delay time until automatically responding to a call, or a change of the response type such as audio response or media message response, the rules for the VMS will be updated, as a result of the instruction processing of the step S36. These updated rules will then be stored in a rules storage S42 of the VMS 6. The rules storage S42 may correspond to, or be part of storing means 7 shown in FIG. 1.

The rules stored in storage S42 may also be read out to the instruction processing step S36, as indicated by an arrow in FIG. 3, for checking a need of updating etc.

In a preferred implementation, rules storage S42 is updated only if both instructions S34 and contents S39 are valid (checking steps S35, S40), and processing of instructions (processing step S36) was successful.

The rules storage S42 cooperates with a Rules maintenance routine or device S44 which performs Housekeeping and checks or monitors expiration of rules. The Rules maintenance routine or device S44 controls the rules storage S42 to store detected changes of rules such as expiration of rules.

Following the instruction processing of step S36, a notification message may be created in a step S37 for notifying the user on proper, or faulty, receipt, and/or proper, or faulty, processing of his/her programming message 10 sent in step S31. This notification message is sent, in a step S38, to the user address indicated in field 12 of the programming message 10.

In a step S40, a content validation is performed with regard to the contents S39 of the message 10 subjected to the message decomposition in step S33. The content validation S40 preferably includes a content type validation, and necessary format conversions.

The contents S39 may consist of, or include, text and/or images and/or pictures and/or audio clips and/or video clips, etc.

When the contents S39 contained in field 15 of message 10 and detected require a change of the content for the VMS such as change of response text or response audio, a content storage S41 of the VMS 6 will be updated so as to store the new contents. The content storage S41 cooperates with a content maintenance routine or device S43 which performs Housekeeping and checks or monitors expiration of content. The content maintenance routine or device S44 controls the content storage S41 to store detected changes of content such as expiration of content.

The content storage S41 may correspond to, or be part of storing means 7 shown in FIG. 1.

In a preferred implementation, content storage S41 is updated only if both instructions S34 and contents S39 are valid (checking steps S35, S40), and processing of instructions (processing step S36) was successful.

The terminal 1 preferably comprises means for preparing one or more programming media messages for programming the automatic call response server 6 in such a manner as shown e.g. in FIG. 2. The programming media message 10 includes the response content 15 which is to be stored in the automatic call response server, and preferably additionally the application specific content 14 which includes authorization information indicating authorization of the sender of the media message to program the call response server. The authorization information can e.g. be or include a PIN code.

The means for preparing the programming media message 10 preferably is or includes an application in the terminal for creating media messages, the application preferably but not necessarily also handling the messaging with the call response server. The application is preferably adapted to assist the user in creation of programming media messages, and may provide assistance in the form of pre-defined or user modifiable forms displayed to the user for filling in.

Preferably, the application comprises or uses a storage internally within the terminal or elsewhere for storing a library of previously created or pre-defined programming media messages. The application may also use an external storage located external to the terminal but accessible for the application and hiding its actual location from the user. This external storage can even be co-located at the VMS. The application may e.g. be adapted to store information on at least one of the status of the automatic call response service and its history.

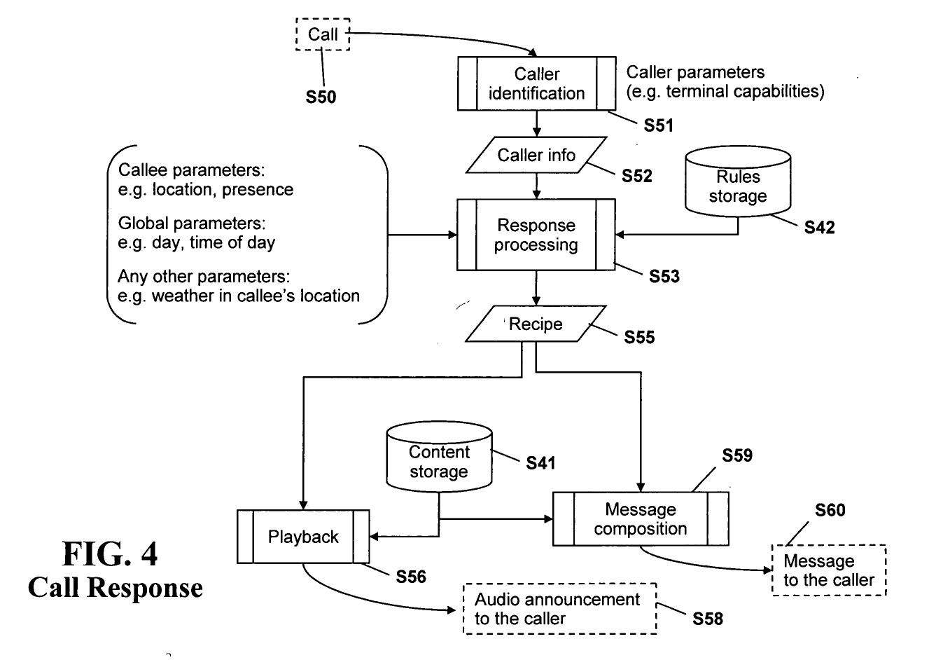

FIG. 4 illustrates an embodiment of a routine, means and/or function for generating an automatic call response.

When a call from a caller is directed to the terminal of the user/callee which has activated his/her automatic call answering function, and the user for some reason does not answer the call, the call is directed to the VMS 6 of the user, step S50. There, caller identification is performed, step S51, wherein the caller identity and caller parameters (e.g. terminal capabilities) are checked.

Terminal capabilities can also be checked from an external database. For checking terminal capabilities, as an example, terminal vendors and operators together can build databases and access to those so that detailed information about the capabilities of each terminal type and version (and those of applications in the terminal) can queried when needed by the services.

A caller info is generated in step S52 which identifies the caller and possibly its parameters. Then, a response processing, step S53, is executed which is based on the actual rules for the automatic call response as stored in the rules storage S42, and preferably takes account of other parameters, too, such as callee parameters: e.g. location, presence; and/or Global parameters: e.g. day, time of day; and/or any other parameters: e.g. weather in callee's location.

These external attributes such as callee's location, weather, etc., can be used to add more sophisticated and complex features to the voice mail service. These attributes are not mandatory but optional extensions. The automatic addition of these attributes can also be used in automatic call response, e.g. VMS, which is not based on the above mentioned media message programming or automatic responding using e.g. MMS, that is it can also be used independent of the other above or below defined features of the invention, or in any arbitrary combination therewith. However, programming or automatic call responding using media messages such as MMS, in addition to intuitive UI, user interface, and easy to use application in the terminal, are suitable technologies to make the service even more feasible, allowing swift and easy programming. As an example, first, the user can create several audio announcements (or fragments of complete announcement), which are stored at VMS. Secondly, the user can program the VMS so that the announcement to be played back is based on VMS-non-specific attributes, such as callee's location. The values of these may be derived from other VMS-external systems such as Presence Server, Location Service, Weather Service etc. Thus, announcements can be automatically adjusted to changing conditions, e.g. “Greetings from sunny Helsinki, I'm currently out of office . . . ”, can be played back when the location of the user is Helsinki, the presence status is out-of-office, and the weather in Helsinki is clear and sunny. The above example also shows that the service is easy and intuitive to use, by providing, according to one aspect of the invention, a computer program product such as the terminal application program or function, or some other means, which hides the complexity of the service.

Based on the actual rules and such other parameters, a recipe S55, that is a program or set of commands, for preparing the actual response is generated which instructs the VMS 6 to generate the actual response.

A playback step S56 is performed for playing, to the caller, an automatic response wherein the audio content stored in the content storage S41 for the called number or identity (e.g. text and music) is played as an Audio announcement S58 to the caller.

In addition to the playback of the Audio announcement S58, or as an alternative thereto, a media message S60, preferably a multimedia message such as an MMS message, may be composed in a step S59, based on the content stored in the content storage S41, and the instructions in the recipe S55. This media message S60 is then sent to the caller as an automatic call response message.

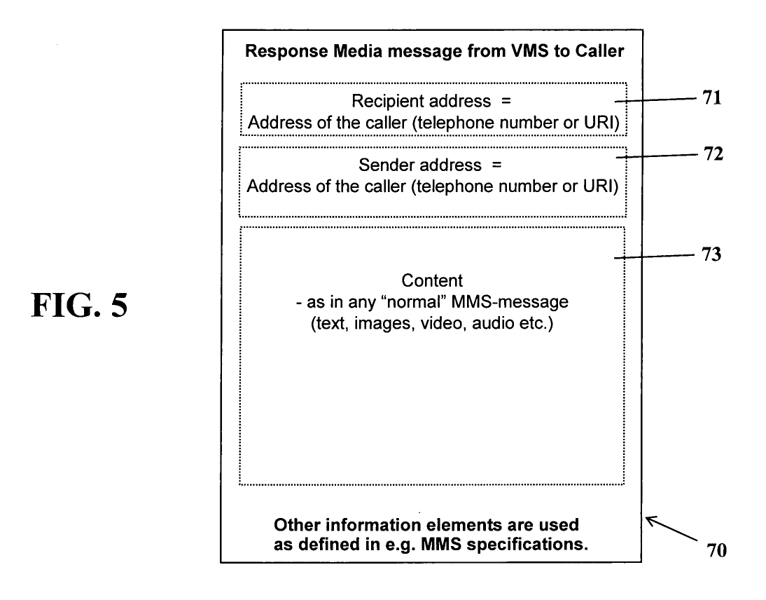

FIG. 5 illustrates an implementation of a structure of a (multi)media message used in an embodiment of the invention for responding to a caller by sending a media message 70. This media message 70 corresponds to message S60 of FIG. 4, and is implemented as an MMS message in this example.

The response message 70 in this case can be a standard MMS message in order to be compliant with the widest possible set of terminals. According to FIG. 5, the media message 70 shown in FIG. 5 includes

a field 71, Recipient address=address of the caller (telephone number or URI),

a field 72, Sender address=address of the caller or of the called number or identity (telephone number or URI),

a content section 73, and

other information elements as defined in the media, e.g. MMS, specifications.

The content section 73 includes a content as in any “normal” media, e.g. MMS, message (text, images, video, audio etc.) The content section 73 corresponds to the response section which includes the response, e.g. audio content and/or other media content such as at least one image or a video etc, selected or set-up/created by the VMS 6 or the user of equipment 1, which content is to be shown or played to a caller whose call is forwarded to, or terminated at the VMS 6. When a call is forwarded to or terminated at the VMS 6, this media message 70 is created and sent to the calling party, that is to the address indicated in field 71.

Preferably the system and method are able to provide different responses to different callers. The callers can be distinguished by their respective caller identifications, e.g. phone numbers. In this case, the media (programming) messages 10 include caller identification, e.g. inserted by the user equipment 1, in field 14. Two or more different media messages 10 are provided, or selected, and transmitted by equipment 1 each including a different caller identification, and possibly different audio content 15 or other different content to be played, shown or sent to the respective caller identified by his caller identification.

These programming messages 10 are processed by VMS 6 so as to store different response contents for the same user. Hence different response contents are stored for different callers trying to reach the same user. When receiving a call forwarded to the VMS 6, the VMS 6 checks the caller identification, selects the stored response content, e.g. audio content, or the respective MMS message, associated to the detected caller, and plays this response content back to the caller, and/or generates and sends a media message including the respective stored response content of the programming messages to the caller.

The invention provides modifications in voice mail systems (VMS) 6 before its implementation in terminals. VMS side may be standardized, or it is ensured some other way that VMSs support the feature.

The function may be built in the phone (and may include sending a pre-recorded message, but maybe also be adapted to check, and update if desired, an existing pre-recorded message).

An interface, for example a standard MM7 interface, may be provided between MMSC 3 or network 4 and VMS 6.

A single destination number to reach voicemail server 6 may be provided, avoiding that the user has to configure it. When the voicemail system exposes or incorporates an interface, e.g. MM7 interface, to the MMSC 3, it can be realised relatively easily.

The invention addresses programming of the automatic voice mail response using a media or multimedia message, e.g. an MMS message. For sending the e.g. MMS programming message to the voice mail server VMS 6 for programming the audio-rich voice mail response, an additional MMS interface in the VMS 6 may be provided which interface is able to transfer the audio-rich message body 15 of the received programming message 10 to the playback voice mail memory for the respective customer using equipment 1. Further, the media messaging interface, e.g. MS interface, or other component implements a check of authorization, for instance a check of the user access code, e.g. PIN, of the customer allowing reprogramming of the voice mail contents of the answering device only when the authorization check is passed. The user access code, e.g. PIN, of the customer is contained in field 14 of the MMS message 10.

As an alternative, or in addition to just playing the recorded audio content, e.g. voice mail announcement, a voice mail server (VMS) 6 or another entity such as MMSC 3 or 5 can store at least the response content of the programming message 10 or the complete programming message, and send a media response message to a caller. This provides a function of media messaging, e.g. MMS, out-of-office assistant, e.g. ‘seasons greetings’. This also enables visual effects. In this case, the caller must have media, e.g. NMS, capable terminal.

In the above case, the voice mail server (VMS) 6 or another entity such as MMSC 3 or 5 is adapted to generate and send a media message, based on the at least partly stored programming message which had been used for programming of the MMS, to a caller. In this case, a media, e.g. MMS, automatic response message will be forwarded to a caller having a media capable terminal. This media response may be played at the caller's terminal, just during the session or thereafter.

Instead of implementing an MMS interface in VMS, the voice mail service can be introduced into the multimedia message service centre (MMSC) 3 or 5. In the above case of generating, based on at least partly stored programming message 10 (at least content field 15 is stored), a media response message, and sending this response message to a caller, the programming media message which includes the automatic voice mail response, is used for programming a voice mail system, and is additionally used for generating a response message to a caller. The media message may be stored in the voice mail server essentially unchanged after stripping of unnecessary or confidential data, or might also be stored in the MMS center 3 or 5 which then additionally acts as a voice mail server.

The media message, e.g. MMS, may be delivered to the user equipment of a caller during the active session or call. The media message, e.g. MMS can be received and processed during the call as it does not use the voice channel. The media message can then be played at the caller's terminal for example just after the end of the session, or even during the session. If the caller's terminal is unable to process the message during the call or session the message may be played automatically or upon selection by the user, after terminating of the call. The media message, e.g. MMS, may be played immediately (caller can play it manually, or a play-mode could be triggered automatically by special indication in the MMS).

Alternatively, the response message is played or displayed after the call is released, and a caller has possibly already left a message in the VMS. Thus, in this case the response media message sending is an additional service to a caller.

An or all embodiments of the invention provide a programming of the automatic voice mail response by sending a media message, preferably a multimedia message such as an MMS message or SIP message, to the voice mail server or MMSC, which message includes audio-rich response content. This audio-rich content is used for programming the automatic response.

When a call is forwarded to a voice mail, VMS can send a MMS to a caller, and/or after a call to a voice mail is released, VMS can send an additional MMS to caller. Preferably, caller's (and e.g. user's) phone number is stored for this later transmitting of the MMS message, when a call is connected.

The embodiments provide a programming of the automatic voice mail response by sending a media message message to the voice mail server which message includes the audio-rich response content. This audio-rich content is used for programming the automatic response.

The storing of at least the response content of the programming message at the server, and the generating of a response media message to be sent to callers who have media-capable terminals, provides the benefit that, for example, when a user prepares the programming media message for VMS, he or she can include both audio and pictures/videos in it. Only audio based objects will be utilised in VMS 6 for playing the message to a caller. However, the pictures and video clips of the media message can be stored in the VMS and can be used in messages sent to callers.

As the media, e.g. MMS message which is intended to program the VMS has some special flags and settings (e.g. PIN code), these are preferably removed before storing the message in the VMS, or at least before sending the response media message to a caller. In particular, field 14 of the message 10 will be removed before storing this message for later forwarding to a caller, or at least before sending it to the caller. Hence, some kind of additional converting is provided in the VMS 6 or MMSC 3, 6.

The VMS is capable of receiving MMSs and is adapted to extract instructions and audio objects from the MMS. In addition, it may be adapted to store the complete message (or the objects in the message) for the purpose of sending multimedia content in a media message to callers who have MMS terminals).

The MMS message might also or alternatively be stored in the MMS center when the latter additionally acts as a voice mail server.

The term media message intends to include “single-media” messages incorporating only one type of media such as text, audio or visual contents, and also multimedia messages having more than one of e.g. the following contents: text, audio or visual contents.

The response service is associated to a user (subscriber) and not directly to a terminal. A user may have several terminals and may use either of them to program the service. The term terminal (1) is intended to mean one or more concrete terminal equipments.

Although preferred embodiments have been described above, the invention is not limited thereto and may also be implemented using other types of media programming messages or different systems or networks.

1. Method for providing a call response function in a communication network which includes a response server, having a storing means, the method comprising the steps of:
a) providing, in a terminal of a user, a media message which includes response content;
b) transmitting the media message from the terminal to the response server; and
c) storing the response content of the media message in the storing means of the response server.

2. Method according to claim 1, further comprising the steps of:
d) forwarding one of a call and a session request from another terminal directed to the user of the terminal, to the response server; and
e) playing one of the response content and a part of the response content as a voice mail announcement to the another terminal.

3. Method according to claim 1, wherein the step of providing the media message comprises providing a Multimedia Messaging Service (MMS) message.

4. Method according to claim 1, wherein the step of providing the media message comprises providing a Session Initiation Protocol (SIP) message.

5. Method according to claim 1, further comprising the steps of:
forwarding one of a call and a session request from another terminal directed to the user of terminal to the server, and
transmitting one of the stored response content and a part of the stored response content to the another terminal in a response media message.

6. Method according to claim 1, further comprising the steps of:
forwarding one of a call and a session request from another terminal directed to the user of terminal to the server;
checking a media capability of the another terminal ; and
transmitting one of the stored response content and a part of the stored response content to the another terminal in a response media message when detecting that the another terminal has media capability.

7. Method according to claim 5, wherein one of the stored response content and the part of the stored response content is additionally played to the another terminal as a voice mail announcement.

8. Method according to claim 5, wherein the transmitted response content includes at least one of audio content, a picture and a video clip.

9. Method according to claim 5, wherein the step of transmitting one of the stored response content and the part of the stored response content in the response media message comprises transmitting one of a Multimedia Messaging Service (MMS) message and a Session Initiation Protocol (SIP) message.

10. Method according to claim 1, wherein the step of transmitting the media message comprises transmitting application specific content.

11. Method according to claim 10, wherein the application specific content is used to program a call response.

12. Method according to claim 11, wherein the application specific content includes information for authentication of a sender of the media message.

13. Method according to claim 12, further comprising checking the information i before authorizing programming of the call response.

14. Method according to claim 12, wherein the information comprises at least a Personal Identification Number (PIN) code for authentication and authorization.

15. Method according to claim 10, wherein the application specific content includes at least one parameter of:
a time of a call;
control information for network provided information/assisted operation;
different messages based on callee's location; and
a validity time of the instructions;
wherein the parameters allow different responses to be one of played to different callers and played at different calling times.

16. Method according to claim 1, further comprising:
providing several different media messages, with different audio contents, in the terminal;
selecting at least one of the provided media messages; and
transmitting and processing the at least one selected media messages.

17. Method according to claim 1, wherein the media message comprises caller identification information, and the method further comprises
storing the response content of the media message in the storing means of the server, and associating the response content with the user of the terminal and with caller identification information.

18. Method according to claim 1, further comprising storing at least two response contents associated with the same user of the terminal and to different caller identification information on the server.

19. Method according to claim 2, wherein, when the one of the call and the session request of another terminal directed to the user of the terminal is forwarded to the server, the server detects a caller identification information of the caller, and one of plays the stored response content to the another terminal, and responds with a media message comprising the stored response content, and wherein the response content is associated with the user of the terminal and with detected caller identification information corresponding to the caller.

20. Method according to claim 1, wherein the step of providing the media message in the terminal comprises providing the media message in a mobile terminal.

21. Method according to any one of the preceding claims claim 1, wherein the server is implemented in a Multimedia Messaging Service (MMS) center (MMSC).

22. System for providing a call response function, in a communication network which includes a response server, having a storing means, comprising:
a) a terminal configured to provide a media message which includes response content; and
b) transmitting means for transmitting the media message from the terminal to the server;
wherein the system is configured to store the response content of the media message in the storing means of the server.

23. System according to claim 22, wherein the system is configured to play one of the response content and a part of the response content to another terminal as a voice mail announcement when one of a call and a session request of the another terminal directed to the terminal is forwarded to the server.

24. System according to claim 23, further comprising:
means for transmitting one of the stored response content and at least part of the stored response content in a new media message to the another terminal.

25. System according to claim 23, further comprising:
means for checking a media capability of the another terminal; and
means for transmitting one of the stored response content and at least part of the stored response content in a new media message to the another terminal when the means for checking determines that the another terminal has media capability.

26. System according to claim 22, wherein
several different media messages, including Multimedia Messaging Service (MMS) messages with different response contents, are provided in the terminal,
at least one of the provided media messages are selected by the terminal, and
the at least one of the selected media message are transmitted and processed in the server.

27. System according to claim 22, wherein the media message includes caller identification information indicating a caller of one of a call and a session forwarded to the server, and
wherein the storing means stores the response content of the media message in the storing means of the server associated with the terminal and with the caller identification information.

28. System according to claim 22, wherein the server stores at least two response contents associated with a same terminal or a same user of the same terminal, and with different caller identification information.

29. System according to claim 22, wherein the server is configured to detect, when a call or a session request of another terminal directed to the terminal is forwarded to the server, caller identification information indicating a caller of the call or the session forwarded to the server, and to play or transmit, to the another terminal, the stored response content which is associated with the terminal and with the detected caller identification information.

30. System according to claim 22, wherein the media message sent to the server includes application specific content.

31. System according to claim 30, wherein the server comprises means for removing the application specific content before storing the response content of the media message.

32. System according to claim 30, wherein the application specific content includes authentication information indicating authentication of a sender of the media message to program a call response.

33. System according to claim 32, wherein the authentication information comprises at least a Personal Identification Number (PIN) code.

34. System according to claim 32, wherein the authentication information is checked before programming the call response.

35. System according to claim 30, wherein the application specific content includes at least one parameter of:
a time of a call;
control information for network provided information/assisted operation;
different messages based on callee's location; and
a validity time of the instructions;
wherein the parameters allow different responses to be played to different callers and at different calling times.

36. System according to claim 22, wherein the terminal is a mobile terminal.

37. System according to claim 22, wherein the server is implemented in a Multimedia Messaging Service (MMS) center (MMSC).

38. Automatic call response server, comprising:
a storing means; and
means for receiving, from a terminal, a media message which includes response content;
wherein the response server is configured to process the media message to derive the response content, and to store the derived response content of the media message in the storing means of the response server.

39. Server according to claim 38, wherein the server is configured to play, when one of a call and a session request of another terminal directed to the terminal is forwarded to the server, one of the response content and at least a part of the response content to the another terminal as a voice mail announcement.

40. Server according to claim 39, further comprising
means for generating and transmitting the media message comprising one of the stored response content and at least a part of the response content to the another terminal.

41. Server according to claim 39, further comprising
means for checking a media capability of the another terminal, and
means for generating and transmitting the media message comprising one of the stored response content and at least a part of the response content to the another terminal when means for checking detects that the another terminal has media capability.

42. Server according to any one of claims 38, wherein the media message sent to the server includes application specific content, and the server further comprises means for processing the application specific content, and means for removing the application specific content before storing the response content of the media message.

43. Server according to claim 38, wherein the server is implemented in a Multimedia Messaging Service (MMS) center (MMSC).

44. Server according to claim 38, wherein the media message includes caller identification information indicating one of a caller of a call and a session directed to the server, and
wherein the server is configured to store the response content of the media message in the storing means of the server associated with the caller identification information.

45. Server according to claim 38, wherein the server is configured to store at least two response contents associated to a same terminal, or a user of the same terminal, and to different caller identification information.

46. Server according to claim 38, wherein the server is configured to detect, when one of a call and a session request of another terminal directed to the terminal is forwarded to the server, a caller identification information indicating a caller of one of a call and the session forwarded to the server, and to transmit or play, to the another terminal, the stored response content which is associated with the terminal and with the detected caller identification information.

47. Terminal comprising:
input means; and
preparing means for preparing a programming media message for programming an automatic call response server, the programming media message including response content which is to be stored in the automatic call response server.

48. Terminal according to claim 47, wherein the preparing means is configured to prepare a Multimedia Messaging Service (MMS) message or a Session Initiation Protocol (SIP) message.

49. Terminal according to claim 47, wherein the programming media message is prepared to include application specific content.

50. Terminal according to claim 49, wherein the application specific content includes information indicating authorization of the terminal to program the call response server.

51. Terminal according to claim 50, wherein the information comprises at least a Personal Identification Number (PIN) code.

52. Terminal according to claim 47, wherein the preparing means is configured to prepare a programming media message comprises caller identification information indicating a caller one of a call and a session directed to the server.

53. Terminal according to claim 47, wherein the means for preparing the programming media message comprises an application in the terminal for creating media messages, the application handling messaging with the call response server.

54. Terminal according to claim 53, wherein the application is configured to assist a user in creation of programming media messages.

55. Terminal according to claim 54, wherein the application provides assistance in a form of pre-defined or user modifiable forms displayed to the user for filling in.

56. Terminal according to claim 53, wherein the application is configured to use a storage within the terminal for storing a library of previously created or pre-defined programming media messages.

57. Terminal according to any one of claims 53, wherein the application is configured to store information on at least one of a status of the automatic call response service and a history of the automatic call response service.

58. Computer program, embodied in a computer-readable medium, configured to be installed in a terminal and configured to create programming media messages for programming a call response server.

59. Computer program according to claim 58, wherein the computer program is an application configured to handle messaging with the call response server.

60. Computer program according to claim 58, wherein the application is configured to assist a user in creation of programming media messages.

61. Computer program according to claim 60, wherein the application is configured to provide assistance in a form of pre-defined or user modifiable forms displayed to the user for filling in.

62. Computer program according to claim 59, wherein the application is configured to use a storage within the terminal for storing a library of previously created or pre-defined programming media messages.

63. Computer program according to claim 59, wherein the application is configured to store information on at least one of a status of the automatic call response service and a history of the automatic call response service.
